(19) United States
(12) Patent Application Publication
(10) Pub. No.: US 2015/0096917 A1
(43) Pub. Date: Apr. 9, 2015

(54) LUBRICATION OIL FINE-TUNING DEVICE FOR OIL TANK

(71) Applicant: Yu-Peng LEE, Taichung (TW)

(72) Inventor: Yu-Peng LEE, Taichung (TW)

(21) Appl. No.: 14/048,058

(22) Filed: Oct. 8, 2013

(51) Int. Cl. B65D 25/34; B65D 81/24; F16N 19/00

(52) U.S. Cl. CPC B65D 25/34; F16N 19/00; B65D 81/24
USPC 206/524.3

(57) ABSTRACT

A lubrication oil fine-tuning device includes a tank having a nano electromagnetic wave coating coated on the outside of the tank. The nano electromagnetic wave coating fine-tunes the lubrication oil particles and the lubrication oil is circulated between parts to smooth the operation of the parts and saves expense of the fuel.

### FIELD OF THE INVENTION

The present invention relates to a device able to fine-tune lubrication oil, and more particularly, to a device coated by a nano electromagnetic wave coating outside of the oil tank.

### BACKGROUND OF THE INVENTION

The expenses for most of the machineries, ships or traffic vehicles and airplanes generally comprises the fuel expense, the maintenance expense and repair expense, wherein the expense for changing engine oil is one of the main expenses among the expenses mentioned above. The engine oil has different standards and quality, if the engine oil does not meet the requirements when using the engines, the friction between working parts is significant and this reduces the life term of the engine. Besides, if the coefficient of the lubrication of the engine oil is low, the engine may consume more fuel than expected.

Most of the vehicles use fuel such as diesel and gasoline, the quality of the fuel affects the operation of the engine. Carbon accumulation happens if the combustion process in the engine is incomplete, and this will cause air pollution and reduces the efficiency of performance of the engine. This situation requires more fuel and the friction between the parts is getting serious. There are many different types of fuel saving devices in the market, wherein two of them are popular, one is a tubular device fixed to the fuel pipe and the other one is a pill which is dropped into the fuel tank. The two types of the fuel saving devices both generate far-infrared energy which fine-tunes the particles of the fuel in the fuel tank and increases the activity of the fuel so as to get a complete combustion in the engine and to reduce the carbon accumulation. However, both of the two conventional fuel saving devices have to be purchased and installed, which are not convenient for the users. The present invention intends to provide a lubrication oil fine-tuning device which has a nano electromagnetic wave coating coated on outside of the oil tank so as to improve the shortcomings mentioned above.

### SUMMARY OF THE INVENTION

The present invention relates to a lubrication oil fine-tuning device and comprises a tank coated by a nano electromagnetic wave coating on the outside of the tank so as to reduce the lubrication oil consumption. The nano electromagnetic wave coating can fine-tune the lubrication oil so that the quality of the lubrication oil can be fineness while operating. Preferably, the tank is adapted to engine system, transmission, differential and so on.

The primary object of the present invention is to provide a nano electromagnetic wave coating coated on the outside of the tank and the nano electromagnetic wave coating is able to fine-tune the lubrication oil in the tank. The device of the present invention is able to extend the parts' usage life of the machine so that it can reduce expense of fuel and lubrication oil.

The present invention has the advantages as following:

1. the present invention can be adapted to any oil tank of vessels, ships, vehicles, industrial machineries.

2. the present invention can fine-tune the particles of the lubrication oil to increase the quality of the lubrication oil and the lubrication oil can be more moisturized so as to extend the life of the machine and reduce the consumption of the lubrication oil.

3. the present invention can reduce the temperature of the lubrication oil while operation so as to reduce friction between the parts.

4. the present invention has the nano electromagnetic wave coating coated on outside of the tank so that the users do not need to purchase the conventional fuel saving devices.

5. the present invention reduces the carbon accumulation and increases the efficiency of engine, also reduces friction between the parts. The performance of the engine is improved and the horse powers and the torques are increased so as to save fuel.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view of the lubrication oil fine-tuning device of the present invention.

### DETAILED DESCRIPTION OF THE PREFERRED EMBODIMENT

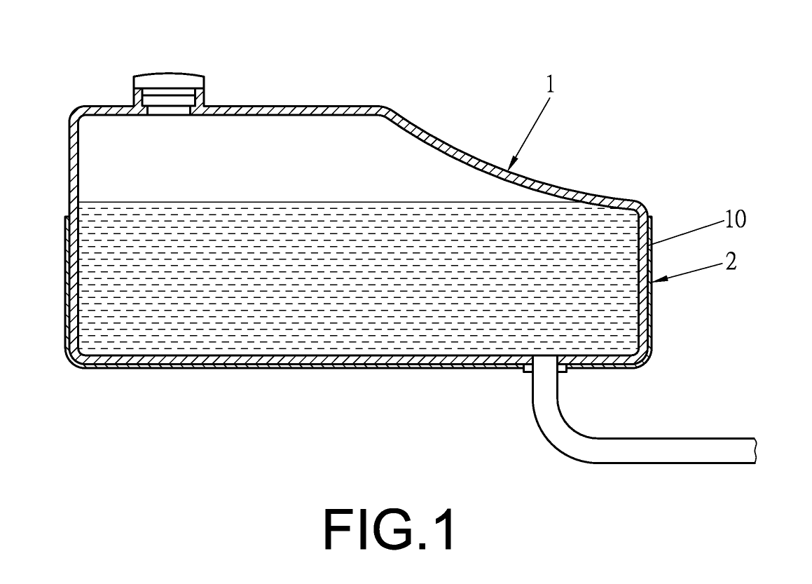

Referring to FIG. 1, the lubrication oil fine-tuning device of the present invention comprises a tank 1 wherein lubrication oil is received. The tank 1 is coated by nano electromagnetic wave coating 2 on the outside 10 thereof The nano electromagnetic wave coating 2 comprises environmentally friendly material and electromagnetic wave energy powders. The nano electromagnetic wave coating 2 releases electromagnetic wave with fixed wave length. The specific electromagnetic wave has the feature of high frequency oscillation so as to structure arrangement coefficient of the molecular of the lubrication oil. The nano electromagnetic wave coating 2 is coated on the outside 10 of the engine oil tank, transmission oil tank or differential oil tank. The high frequency oscillation of the electromagnetic wave cuts the structure of molecular and fine-tunes the particles of the lubrication oil which is circulated between parts of the engine, the transmission system or the differential system. The lubrication coefficient of the lubrication oil is improved so that the parts are well protected under high operating temperature, also the surface of the lubrication oil is not broken by the shear force under high operation temperature. The nano electromagnetic wave coating 2 of the present invention is easily coated on the outside 10 of the engine oil tank, the transmission oil tank or the differential oil tank. The nano electromagnetic wave coating 2 of the present invention can also be coated on the underside of a compressor to provide better lubrication feature.

While we have shown and described the embodiment in accordance with the present invention, it should be clear to those skilled in the art that further embodiments may be made without departing from the scope of the present invention.

What is claimed is:

1. A lubrication oil fine-tuning device comprising:
a tank coated by a nano electromagnetic wave coating on outside of the tank.

2. The device as claimed in claim 1, wherein the tank is adapted to engine system, transmission and differential.
